(19) United States
(12) Patent Application Publication
(10) Pub. No.: US 2019/0047840 A1
(43) Pub. Date: Feb. 14, 2019

(54) MODULAR FLUID-DOSING SYSTEM AND ITS PROCESSES

(71) Applicant: ELECTRO CONTROLES DEL NOROESTE S.A. DE C.V., Hermosillo (MX)

(72) Inventors: Alvaro RENDON MONTOYA, Hermosillo (MX); Jose Antonio BRETON ANGULO, Hermosillo (MX); Luis Obed LUGO GRANADOS, Hermosillo (MX)

(21) Appl. No.: 16/078,761

(22) PCT Filed: Feb. 23, 2016
(86) PCT No.: PCT/MX2016/000017

§ 371 Date: Aug. 22, 2018

(51) Int. Cl. B67D 3/00

(52) U.S. Cl. CPC B67D 3/0041

(57) ABSTRACT

A modular fluid-dosing system includes at least one hosting structure, a logic module and several dosing modules set up to add one or more fluids in one or more dosing points during a process, where an exact amount of a substance is necessary, using a manifold system. One of the dosing modules may be a dedicated module, specifically designed to add one reagent within one dosing point. Additionally, one of the dosing modules may be a multiplexor module, which permits the adding of the same fluid along several dosing points in a sequential manner. This is a flexible system that can have different configurations, combining dedicated and multiplexor modules that are required according to the needs of the process. Dosing modules are installed on support devices that permit reconfiguring the system structure according to the needs of the dosing process without affecting the internal design of the distribution system.

### INVENTION FIELD

As mentioned in the title of this descriptive report, this invention falls within the fields of mechanics and electronics; pertaining specifically to a fluid controller system designed to control the exact amount of fluids being added during different stages of a process.

### SUBJECT MATTER OF THE INVENTION

This invention refers to a modular fluid dosing system; the objective of such is to optimize the process through which specific amounts of fluids are added along different points of an industrial plant.

A system able to reach the controlled addition of the exact amounts of diverse fluids has been developed through the module's design and subsequent integration. An example is the addition of reagents into different flotation cells during a mineral extraction process.

### BACKGROUND

In the mining industry, the common practice currently uses peristaltic pumps for the addition of reagents to the flotation cells. The disadvantage of these types of pumps is the wear on internal components due to continuous use. Such wear has become notorious in the first few months after installation thus reducing the precision of the amount of fluid pumped.

The replacement of said internal components of a peristaltic pump involves a halt in the dosing process. This replacement should be carried out frequently, between 1 to 6 months depending on the reagent, in order to keep the specific amounts of reagent flows in the process. In turn, the pumps themselves also wear over time, which implies the total replacement of the dosing equipment within a period between six months and a year. Out of necessity then, several devices that allow for reagent flow in a variety of ways have been designed.

The document with the patent application number MX/a/2013/005730, describes a fluid-dosing device for use in the mining field. This consists of a logical module, a flow meter and a control valve installed on a metal structure. Through its Graphical User Interface or GUI the device's operation can be programmed thus reaching the exact dosing of the reagent by using the flow meter and the control valve together.

The document U.S. Pat. No. 7,712,486B2 describes a modular surface-mount collection system that consists of a connection of flow control fittings through a connection bridge formed by conduction elements. These can be used for controlled distribution of fluids.

To reach the desired results however, the mining industry requires the simultaneous operation of several extraction processes, which in turn require the dosing of reagents during several points of said processes.

The foregoing reveals the need to reach an efficient addition of one or more reagents in a precise manner regarding both quantity and time. This objective has yet to be achieved through the in-use devices and systems that exist as part of the latest technical developments. It has, however, been achieved by the invention presented herein through its innovative and novel design.

### BRIEF DESCRIPTION OF THE FIGURES

FIG. 1.—External structure proposed for the modular fluid-dosing system, specifically two isometric views of both the logical module and the hosting structure.

FIG. 2.—Side view of the hosting structure proposed for minor components.

FIG. 3.—Rear isometric view of the hosting structure proposed for minor components.

FIG. 4.—This shows the flow diagram corresponding to the dedicated module.

FIG. 5.—Top view of the external structure proposed for the dedicated module.

FIG. 6.—This shows the flow diagram corresponding to the multiplexor module.

FIG. 7.—Top view of the external structure proposed for the multiplexor module.

FIG. 8.—Detailed top view of the structure proposed for the flow meter of the multiplexor module and its fittings.

FIG. 9.—Detailed top view proposed for the valves of the multiplexor module and its fittings.

FIG. 10.—This shows a detailed flow diagram of the connection of the flow meter with a sub-network of the multiplexor module.

FIG. 11.—This shows a detailed flow diagram of a sub-network of the multiplexor module.

FIG. 12.—Side view of the external structure proposed for the multiplexor module.

FIG. 13.—Front view of the external structure proposed for a sub-network of the multiplexor module.

FIG. 14.—Top view of the external structure proposed for the multiplexor module, with arrows that indicate the direction of the normal flow.

FIG. 15.—Front view of the external structure proposed for a sub-network of the multiplexor module, with arrows that indicate the direction of the normal flow.

FIG. 16.—Top view of the external structure proposed for the multiplexor module, with arrows that indicate the direction of deviated flow.

FIG. 17.—Front view with arrows that indicate the directions of the normal flow of a sub-network of the multiplexor module, with arrows that indicate the direction of deviated flow.

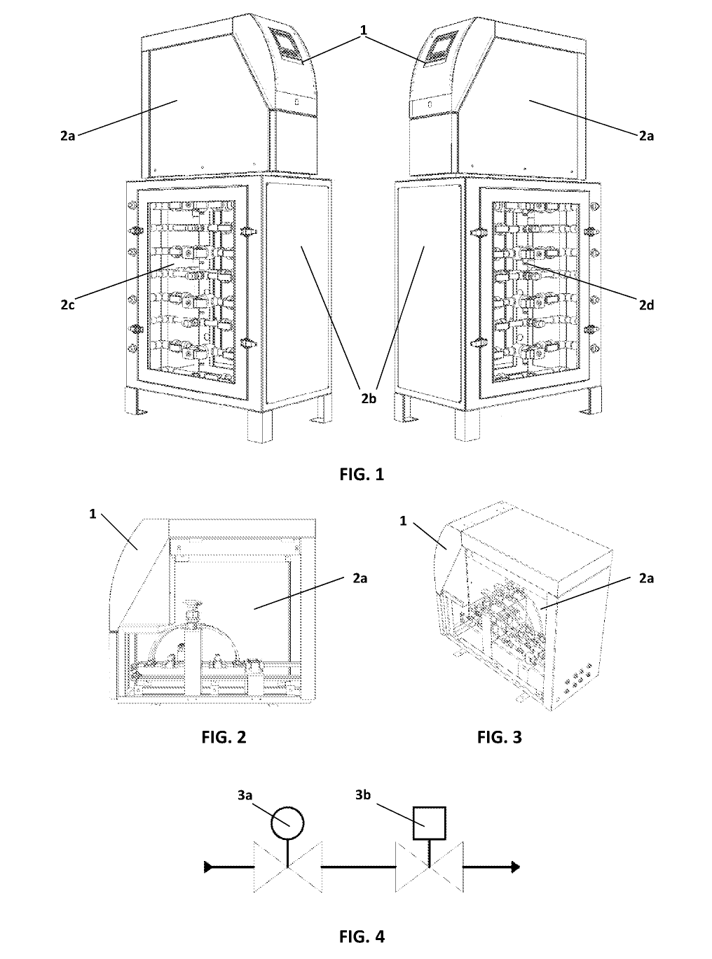

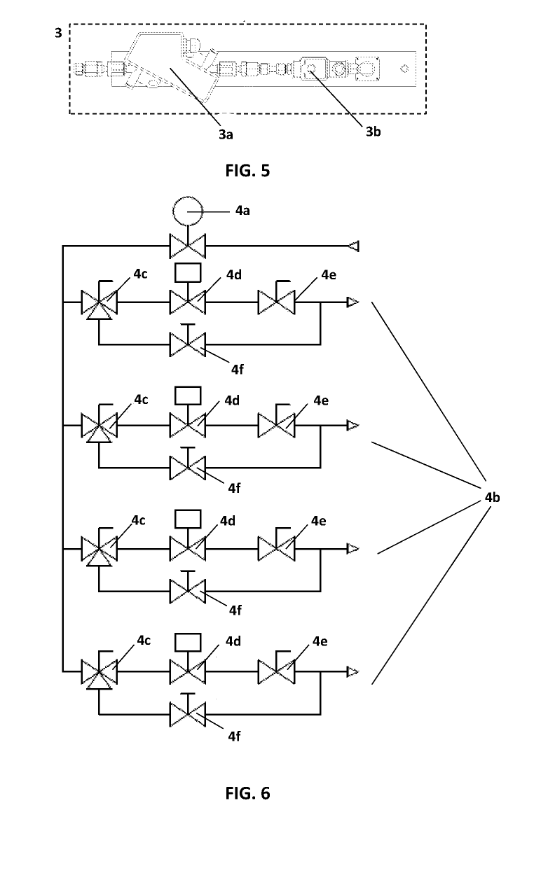

### DETAILED DESCRIPTION OF THE INVENTION

This descriptive report describes a fluid-dosing system that allows for the addition of exact amounts of diverse substances during certain points of a process, according to parameters defined by an operator.

The system described herein includes a logic module (1), at least one dedicated dosing module (3), and/or at least one multiplexor dosing module (4). Dosing modules are installed in a hosting structure that provides support during their operation.

Logic Module

The logic module (1) includes a controller, generally a PLC (Programmable Logical Controller), and electronic circuits characteristic of these types of controllers that allow for proper operation. Other types of controllers can be used without limiting the function of the dosing system. The logic module may include an LED screen where a graphic user interface is visible, through which it is possible to configure the parameters that govern the function of the dosing device. It is also possible that the logic module does not have a screen, and that all programming and parameters may be configured from the time they are manufactured or from the process control room.

Additionally, it has a printed circuit board (PCB) that is used as an interface for electrical connections between the controller and the electronic components of the dosing system such as control valves and flow meters. The use of a PCB involves a reduction in manufacturing time as well as in the dimensions and components of the logic module, which normally will also include the fittings necessary for a controller; for example, several wire clamps that function as electric protection for the controller.

Dedicated Module

This is a pipeline independent block (3) and fittings that include a flow transmitter (3a) and a control valve (3b), both installed sequentially in order to provide continuous flow and control to a fluid. When its dimensions permit it, up to four dedicated modules can be installed within the hosting structure for minor components (2a). When the dedicated modules have large dimensions, a hosting structure for major components (2b) will be used, which will be divided into two sectors. Within each sector of the housing structure (2b) up to four dedicated modules can be installed (3), and it is possible to have in the system up to eight independently-controlled continuous flows, four in each sector.

Multiplexor Module

This block (4) is comprised of a flow meter (4a) and valve arrangements connected in a tree network structure. Valves are installed in up to six sub-networks, also known as Multiplexor Dosing Modules (4b).

Each sub-network (4b) is comprised of a three-way valve (4c), two control valves (4d) (4f) and a shut-off valve (4e), installed sequentially on a support plate (4g) to provide determined fluid flow in a controlled manner. Control valves (4d) (4f) are installed in parallel among them in order to use the second one (4f) as a bypass with the three-way valve (4c) when the first control valve (4d) is receiving maintenance. The shut-off valve (4e) prevents fluid from returning through the pipe when the bypass of the flow of the first control valve (4d) is applied toward the second control valve (4f). All sub-networks are connected to one flow meter (4a), which controls the amount of fluid that passes through each sub-network (4b).

With this sub-network distribution arrangement it is possible to design a dosing cycle that adds the same fluid in different or equal amounts along different points of a process according to the estimations carried out for its optimal operation. The dosing cycle will be defined by the amount of determined time, during which the fluid will be measured out in given amounts by means of a sequential manner through each module sub-network. The advantage? Only one flow meter is required for the complete network.

Hosting Structures

The logic module and dosing modules require a structure that provides support while they are in operation. When the dosing modules array and when the dimensions of its respective components permit it, these can be installed on a hosting structure for minor components (2a), using the same framework for the logic module and dosing modules. When the dimensions of the components exceed the capacity of the first hosting structure (2a), it is possible to use a second hosting structure (2b). This hosting structure for major components (2b) is a tower divided in two sectors (2c) (2d), one on each side of the structure, in order to keep the configuration of the dosing modules organized; allowing maintenance, replacement or relocation of any of them within the hosting structure (2b) without affecting the rest of the system.

The modules are installed in such a way so as to form a manifold-type distribution system, which allows dosing one or several fluids along various dosing points using the different types of dosing modules, meeting the industry requirements in place where the system is going to be used.

The modules are interchangeable with each other since they are installed on racks in such way that the structure of the dosing device is flexible for making changes in the configuration according to the process needs.

The adaptability of the configuration permits the installation, in each sector (2c) (2d) of the hosting structure for major components (2b), of up to four dedicated modules (3) or up to two multiplexor modules (4), depending of the pipe diameter that is used in the modules. The hosting structure for major components (2b) may be configured to have a combination of dedicated and multiplexor modules in the same tower sector.

### PREFERRED EMBODIMENT OF THE INVENTION

The fluid dosing system described in this descriptive report is designed to be applied primarily in the extractive mining industry, specifically within the milling and flotation processes, adding any given reagents in the amounts necessary to reach optimal separation and extraction of the minerals involved in the process. However, this system may be used in other types of processes that similarly require fluid dosing such as the ones used in the food, drink, petroleum, and gas industries.

The control valves (3b) used in the dedicated modules (3) may be solenoid valves that either permit or prevent the pass of the fluid through the system up to the process site where it is necessary to add the reagent.

The control valves (4d) (4f) used in each network of a multiplexor module are defined according to their position in the module. The control valve located in the flow main line (4d) can be a solenoid valve connected to the three-way valve (4c) on the one side, and a shut-off valve (4e) on the other side. The second control valve (4f) installed in parallel to the solenoid valve (4d) may be a needle valve, which permits or prevents the pass of the fluid during the time the solenoid valve (4d) is receiving maintenance.

Dosing parameters of the logic module (1) can be set up locally through a Graphical User Interface (1a), and remotely from the process control room. It is also possible for the logic module (1) to be set up to follow programmed dosing parameters from the date of manufacture.

Generally, meeting the dosing parameters is reached through the PID control loop, whose parameters are programmed from the design and manufacture of the equipment. However this does not limit the use of other control strategies that can have the same results.

To begin the dosing process, the reagent is extracted from the storage tanks through pumps or gravity, and transported through diverse conduction elements up to the dosing system, where it will be measured and sent to the point of the process where its application is necessary.

In the event that the reagent is necessary only in one dosing point, the reagent is directed to a dedicated module (3) where the flow meter (3a) and the solenoid valve (3b) adjust the amount of fluid that passes per unit of time according to the programmed parameters in the logic module PID control loop (1). Next, the solenoid valve (3b) is opened to dispense the fluid to be measured out. After this fluid circulates through the dedicated module (3), the fluid is conducted through diverse means up to the point of the process where it will be added. The means may be hoses, pipes, or other devices whose dimensions and composition are suitable for transporting the fluid.

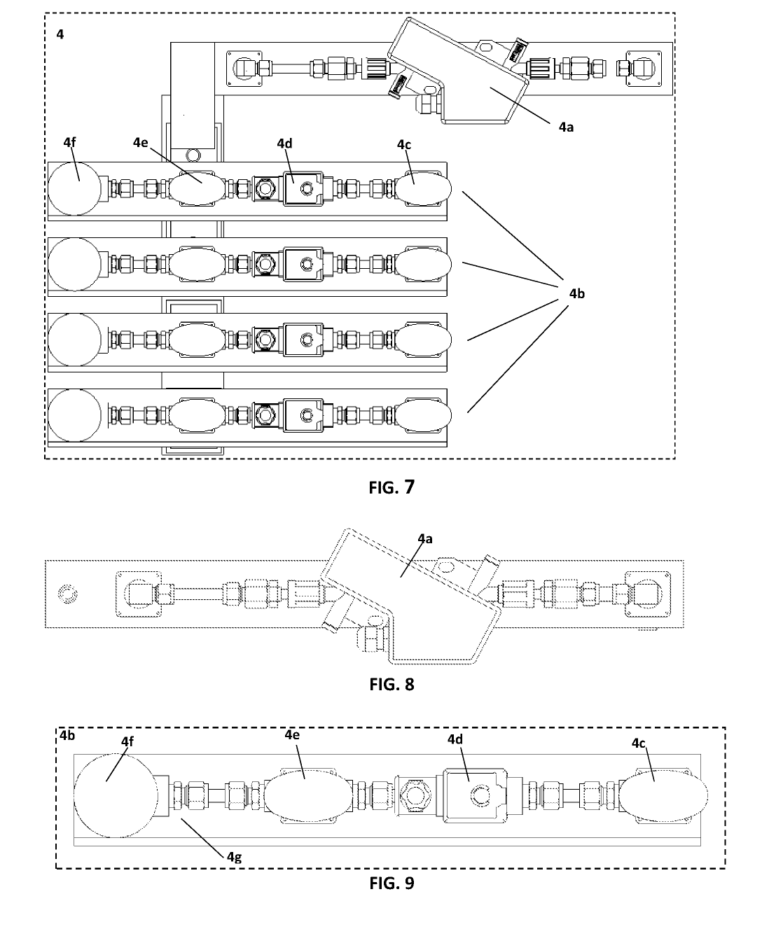

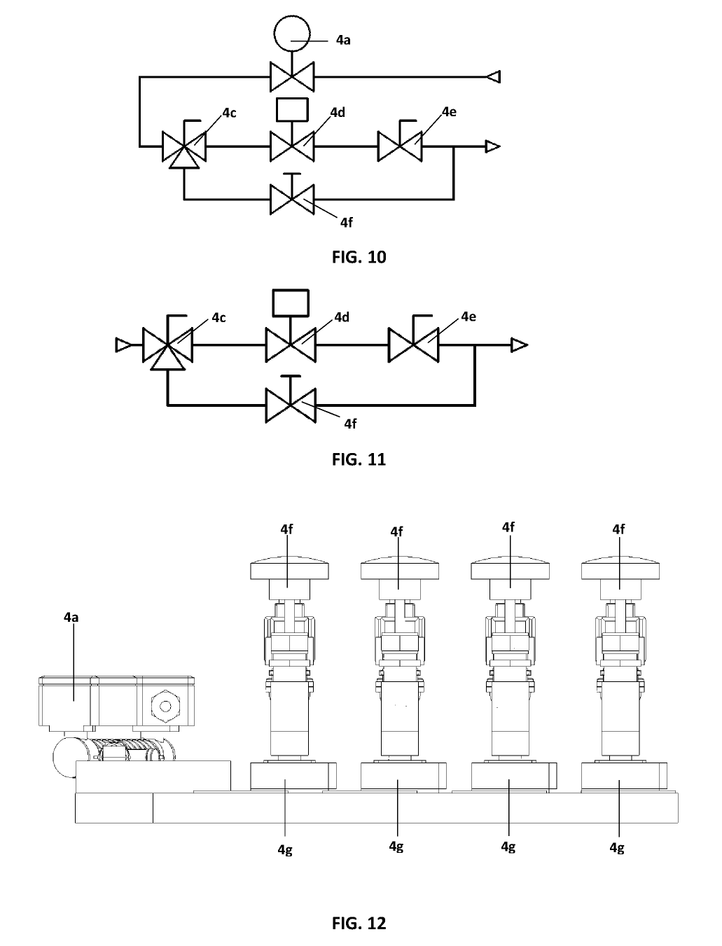

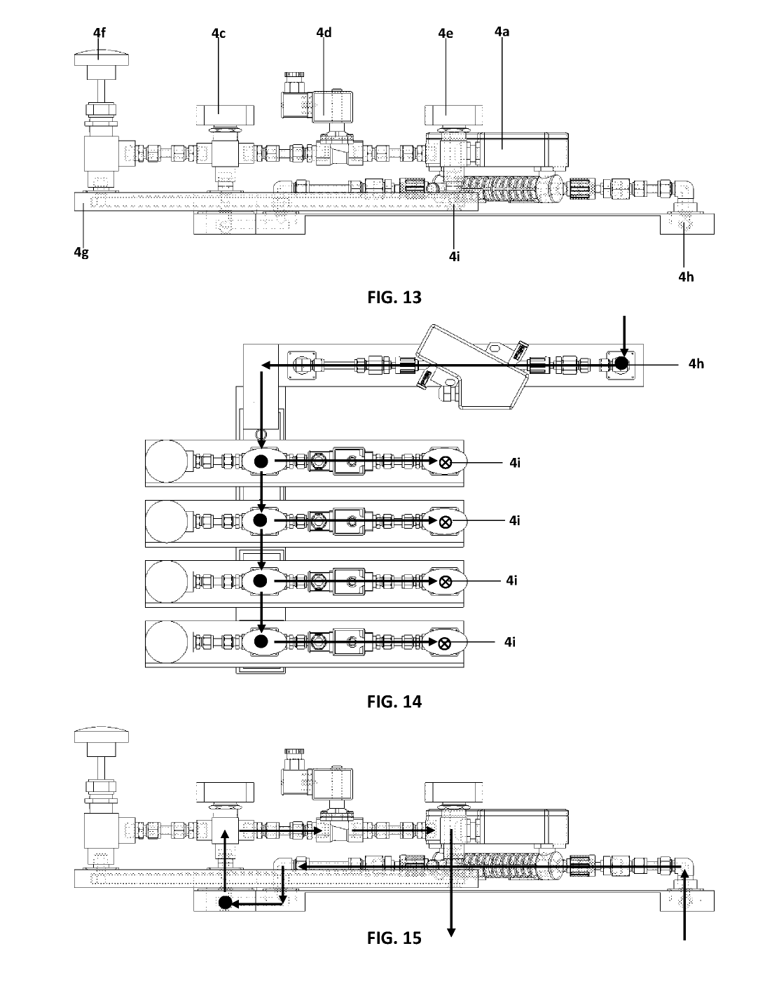

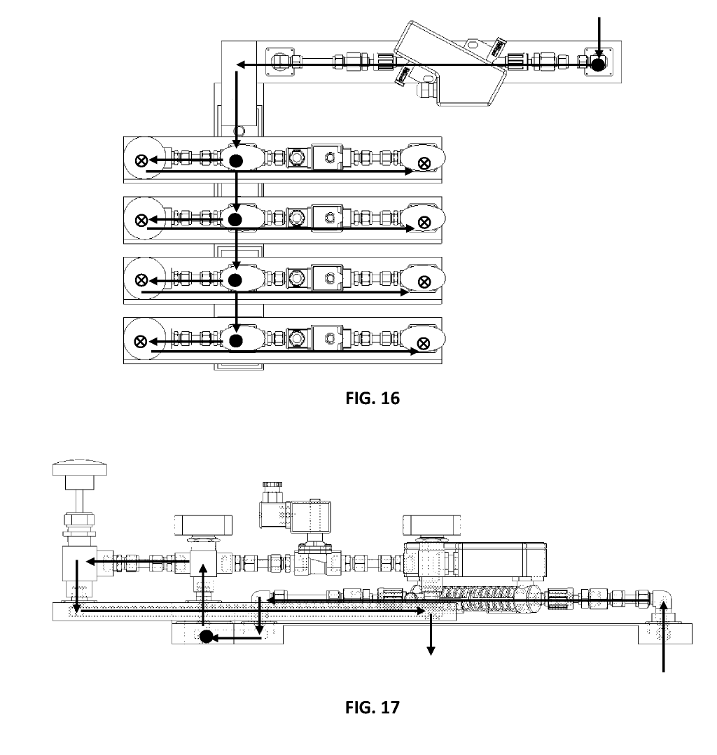

For a process where it is necessary to measure out the same reagent along several dosing points, the reagent is directed toward an entry point (4h) of a multiplexor module (FIGS. 7, 8, 9, 14 and 15) where the flow meter (4a) and the solenoid valve (4d) adjust the fluid amount that passes per unit of time in a PID control loop, according the instructions programmed in the logic module (1). The reagent is directed to the three-way valve (4c) of a first sub-network (4b), normally closed for the needle valve (4f) and open for the reagent entry and for the solenoid valve (4d). The fluid passes through the solenoid valve (4d) to finally circulate through the shut-off valve (4e) toward the exit point (4i) of the sub-network. For a process where it is necessary to measure out the same reagent along several dosing points while the solenoid valve (4d) is receiving maintenance, the reagent is directed to a multiplexor module (FIGS. 7, 8, 9, 16 and 17) where the operator adjusts a determined flow amount to pass through the needle valve (4f). The reagent is directed to the three-way valve (4c) of the first sub-network (4b); usually closed for the solenoid valve (4d) and open for reagent entrance and needle valve (4f). The flow passes through the needle valve (4f) to finally circulate through a conduit up to the sub-network exit point (4h).

After circulating through the sub-network (4b), the reagent is conducted using various means up to the process point where it will be added. These means may be hoses, pipes or other devices having the proper size and material to transport the fluid.

The same series of steps is followed for each sub-network module, functioning one after the other, and circulating a determined amount of reagent each time. While a sub-network is in operation, the solenoid valves of the rest of the sub-networks will remain closed, and the logic module determines the order in which the valves should open and close to allow the reagent dosing in such a way that there are never two solenoid valves open at the same time.

The optimal time period determined for the operation of the multiplexor module is one minute according to current international industrial standards, which dictate the dosage in unit volume per minute. The foregoing implies that the logic module divides this minute between the several stages that require the reagent, and carries out the necessary estimations to determine the operation of the flow meter, which allows the circulation of the flow amount specified by the logic module through each sub-network.

For example, if it is necessary to add the amounts of 200 cm³/min, 300 cm³/min and 500 cm³/min to a given process of the same reagent in three different dosing points, the logic module determines that it is necessary to measure out one liter of reagent within one minute. The operation of the three sub-networks is sequentially activated, and this corresponds to the three amounts programmed in the logic module. The first sub-network will be allotted 12 seconds to measure out 200 cm³. The second sub-network will be activated during 18 seconds to measure out the following 300 cm³, and the third sub-network will measure out the remaining 500 cm³ in 30 seconds; thus, completing the one liter measured out within one minute.

It is necessary to clarify that the opening and closing of valves require certain allotted time, which may be minimal but must be considered nonetheless. Therefore, a safety factor of one second per solenoid valve must be considered in order to permit proper fulfillment of the dosing cycle.

Some of the indications and requirements that should be met for the installation of dosing systems are the use of open screws placed on the ground, no footings are needed, and several hose and pipe connections are required for the transport of fluids from the storage location to the dosing system and from there to the dosing points.

The dosing system must be installed in the location that the process engineer considers to be the most appropriate according to the location of the equipment that will receive the reagent dose. The installation should be performed inside and under normal humidity and temperature conditions; the temperature should be lower than a 60° C. at all times. Additionally, the ground level should be horizontal. If the installation of the dosing system is performed outside, it is necessary to build a booth to guard the equipment.

### INVENTION ADVANTAGES AND INNOVATION

The use of this fluid-dosing system compared to other existing systems in the market has a number of benefits.

First and foremost, it is a modular system that permits configuration according to the needs of the fluid-dosing industry, selecting the type of module that will be used for each fluid according to the number of dosing points where the fluid has to be added. Owing to this innovative design, it is possible to operate the reagent dosing in an effective, accurate, and simple manner, through a distribution system controlled with an easy-to-use user interface. Being modular allows for easy maintenance and replacement of one or more control items such as the dosing module's valves and flow meters without affecting the general system distribution array, since the lines that communicate these control items are within the structure while the connections are superficial.

Additionally, a direct contract of the operator with the fluid through instrumented equipment is prevented, whose components and accessories provide precision and accuracy in the measured out flows.

Regarding its operation, this system offers flexibility to use manual, remote, or automatic control according to the needs of both the operator and the plant that uses the process. The time necessary to provide minor maintenance increases up to six months. Similarly, major maintenance is necessary after two years. Equipment replacement is advised after five years of use in order to keep the accuracy of the dosing.

The average time to recalibrate the equipment is extended to six months, compared to only two weeks required by the recalibration of the equipment that uses peristaltic pumps.

The increase of the time necessary to provide maintenance and recalibration results in a decrease in economic and human resources to perform such activities.

1. Modular Fluid-Dosing System, comprising:
a logic module;
a hosting structure;
a dedicated module set up to measure out one fluid in one sole point of one or more processes that includes at least a flow meter and a control valve; and
a multiplexor module set up to measure out one sole fluid in different points of one or more processes that includes at least one flow meter, a three-way valve, two control valves, and one shut-off valve; and
a logic module that is connected via electronic means to at least one control valve and one flow meter of the dedicated module and/or at least one control valve and one flow meter of the multiplexor module, wherein at least one dedicated module and/or one multiplexor module are installed in the hosting structure forming a manifold that measures out one or more fluids.

2. Modular Fluid-Dosing System according to claim number 1, further comprising a logic module having one controller that can be set up locally through the Graphical User Interface, remotely from the process control room, or from the moment it was manufactured.

3. Modular Fluid-Dosing System according to claim number 1, further comprising a logic module connected to at least one control valve and one flow meter of the dedicated module, or at least one control valve and one flow meter of the multiplexor module using a PCB interface.

4. Modular Fluid-Dosing System according to claim number 1, further comprising a logic module having either a traditional or touch screen that operates as a Graphical User Interface.

5. Modular Fluid-Dosing System according to claim number 1, further comprising a hosting structure, which includes a casing and internal frames set up to host several, dosing modules.

6. Modular Fluid-Dosing System according to claim number 1, further comprising a dedicated module control valve that is a solenoid valve.

7. Modular Fluid-Dosing System according to claim number 1, further comprising at least one multiplexor module control valve that is a solenoid valve.

8. Modular Fluid-Dosing System according to claim number 1, further comprising a multiplexor module three-way valve that acts as a bypass toward the second control valve.

9. Modular Fluid-Dosing System according to claim number 1, further comprising a multiplexor module second valve that is a needle valve.

10. Process to measure out fluids, comprising:
1) Entering into a control program of a logic module an operator's identification data
2) Defining at least one dosing set point
3) Giving the start up order of a dosing cycle
4) Opening a control valve of a dosing module
5) Measuring the amount of fluid through one flow meter in the dosing module
6) Closing the control valve of the dosing module
7) Repeating steps 4, 5 and 6 during a certain amount of time wherein a logic module is connected via electronic means to at least one dosing module; wherein at least one dosing module is a dedicated module set up to measure out one fluid within one point of one or more processes that include at least one flow meter and one control valve; and wherein at least one dosing module is a multiplexor module set up to measure out one fluid along different points of one or more processes that include at least one flow meter, one three-way valve, two control valves, and one shut-off valve.

11. Process to measure out fluids according to claim number 10, further comprising a logic module that includes an electronic system that is a PLC (Programmable Logic Controller) that may be setup locally through a Graphical User Interface, remotely from the process control room, or from the moment it was manufactured.

12. Process to measure out fluids according to claim number 10, further comprising means of electronic connection between the logic module and the dosing module that include a Printed Circuit Board or PCB.

13. Process to measure out fluids according to claim number 10, further comprising a logic module that includes a traditional screen or a touch screen that operates as a Graphical User Interface.

14. Process to measure out fluids according to claim number 10, further comprising a dedicated module control valve that is a solenoid valve.

15. Process to measure out fluids according to claim number 10, further comprising a multiplexor module first control valve that is a solenoid valve.

16. Process to measure out fluids according to claim number 10, further comprising a multiplexor module three-way valve that operates as a bypass toward a second control valve.

17. Process to measure out fluids according to claim number 10, further comprising a multiplexor module second control valve which is a needle valve.
